(19) United States
(12) Patent Application Publication
(10) Pub. No.: US 2013/0205224 A1
(43) Pub. Date: Aug. 8, 2013

(54) ELECTRONIC DATA PLATE SYSTEM FOR COLLABORATION AMONGST MULTIPLE DISPARATE PARTIES

(71) Applicants: James O. Grundvig, New York, NY (US); Leif Grundvig, Lysaker (NO); Jack Cheng, Fanling (HK)

(72) Inventors: James O. Grundvig, New York, NY (US); Leif Grundvig, Lysaker (NO); Jack Cheng, Fanling (HK)

(21) Appl. No.: 13/744,076

(22) Filed: Jan. 17, 2013

Related U.S. Application Data
(60) Provisional application No. 61/588,022, filed on Jan. 18, 2012.

(51) Int. Cl. G06F 3/048

(52) U.S. Cl. CPC G06F 3/048
USPC 715/751

(57) ABSTRACT

The present invention teaches, among other things, a graphical user interface system for enhancing the management of budgeting and scheduling of projects serviced by and among a plurality of independent parties, comprising, in combination, the steps of: providing a color-coded, multi-tier graphical user interface which illustrates a value-based sequence of project data, said interface being capable of providing the system user with physical and virtual product data relating to one or more of the industries such as, without limitation, architecture, construction, and filmmaking; capturing information relating to at least one particular trade; presenting captured data as a plurality of mini-projects; storing and linking data flow activities for a system user operation; providing based upon resource value and schedule a Web or cloud-based software-as-a-service model in a tree-like interactive graphic; graphically presenting to the system user the status of a given project; providing the system user, by one or more color changes, a relatively instantaneous snapshot of project status; and providing data searchable to the system user on the Web.

This application claims the benefit of priority pursuant to 35 U.S.C. 119(e) from a U.S. provisional patent application having Application No. 61/588,022 filed Jan. 18, 2012.

### BACKGROUND OF THE INVENTION

This invention relates to scheduling and budget management for projects in which multiple disparate parties must collaborate. For example, in the construction industry, the major parties that must collaborate on a construction project (i.e. engineers, architect, contractors, subcontractors, etc.) each use their own scheduling and budget management tools. These tools, which are often just a spreadsheet, do not easily work together, thus making it difficult for parties to collaborate on a major project.

### OUTLINE OF ASPECTS OF THE INVENTION

The present invention teaches, among other things, a graphical user interface system for enhancing the management of budgeting and scheduling of projects serviced by and among a plurality of independent parties, comprising, in combination, the steps of: providing a color-coded, multi-tier graphical user interface which illustrates a value-based sequence of project data, said interface being capable of providing the system user with physical and virtual product data relating to one or more of the industries such as, without limitation, architecture, construction, and filmmaking; capturing information relating to at least one particular trade; presenting captured data as a plurality of mini-projects; storing and linking data flow activities for a system user operation; providing based upon resource value and schedule a Web or cloud-based software-as-a-service model in a tree-like interactive graphic; graphically presenting to the system user the status of a given project; providing the system user by one or more color changes a relatively instantaneous snapshot of project status; and providing data searchable to the system user on the Web.

### SUMMARY OF THE INVENTION

The present invention solves the problems in collaboration found in the prior art by implementing an Electronic Data Plate (EDP), which provides a color-coded, multi-tier plate system. A series of EDPs will form a value chain of data for a project with a variety of physical and virtual products, spanning a broad range of industries, for example but not limited to architecture-construction, filmmaking, and other fields. The EDPs will capture information for a particular trade and then pool the data as a series of smaller mini-projects. The EDPs will store and link all activities and items associated with the flow of data and resources for each task or operation. The EDP will be set in a Web-based or cloud-based software-as-a-service (SaaS) software solution model, displayed in a project tree. This is done by resource, value and schedule. In the latter, they will be set in interactive screen as a chain of sequential workflows and/or events, connecting information from various associations with one another. The graphic user interface will show the current status of all EDPs on a given project, from the review of a product by the architect up to completion. After the review, the color-coded system will change the top plate, thus providing an instant snapshot of the global project status. The top plate information will be stored and accessed in a project cloud (private) ecosystem, hosted on a third-party datacenter. The second plate will display a searchable supply cloud (public) of all the product data, literature, and documents. The third tier plate of the EDP will focus on calculating the scorecard for environmentally friendly (green) construction materials and certificates. When docked with the private and public clouds of the top two plates, this plate will provide a hybrid cloud, bridging both the project and supply clouds for each task and product information stored in the specific EDP. The fourth plate of the EDP will dock directly under the third plate. This will be a resources plate that will connect all product related information, from costs to design elements. When shown in series, the value of each EDP will appear on the top color-coded plate. This feature will reveal project bottlenecks in terms of value, deliverables, and other data. The EDP model of stacked data plates will create a hierarchical composition of project information enabling stakeholders to derive new metrics to monitor and assess progress throughout the project lifecycle.

### BRIEF DESCRIPTION OF THE DRAWING

FIG. 1 illustrates a captured computer screen shot of the overall CNBUILDER architecture according to the present invention;

FIG. 2 illustrates a captured computer screen shot of the CLOUDNICIAN home page according to the present invention;

FIG. 3 illustrates a captured computer screen shot of the owner/developer portal according to the present invention.

FIG. 4 illustrates a captured computer screen shot of the construction manager portal according to the present invention.

FIG. 5 illustrates a captured computer screen shot of the bank/investor portal according to the present invention;

FIG. 6 illustrates a captured computer screen shot of the architect of record portal according to the present invention;

FIG. 7 illustrates a captured computer screen shot of the engineer of record portal according to the present invention;

FIG. 8 illustrates a captured computer screen shot of the specialty engineer portal according to the present invention;

FIG. 9 illustrates a captured computer screen shot of the general contractor portal according to the present invention;

FIG. 10 illustrates a captured computer screen shot of the subcontractor portal according to the present invention;

FIG. 11 illustrates a captured computer screen shot of vendor/supplier portal according to the present invention;

FIG. 12 illustrates a captured computer screen shot of the EDP map according to the present invention;

FIG. 13 illustrates a captured computer screen shot of the detailed EDP screen according to the present invention;

FIG. 14 illustrates a captured computer screen shot of the spec deck screen according to the present invention;

FIG. 15 illustrates a captured computer screen shot of the spec screen according to the present invention;

FIG. 16 illustrates a captured computer screen shot of the RFI deck screen according to the present invention;

FIG. 17 illustrates a captured computer screen shot of RFI screen according to the present invention;

FIG. 18 illustrates a captured computer screen shot of the submittals deck screen according to the present invention;

FIG. 19 illustrates a captured computer screen shot of the submittal screen according to the present invention;

FIG. 20 illustrates a captured computer screen shot of the vendor deck screen according to the present invention;

FIG. 21 illustrates a captured computer screen shot of the vendor screen according to the present invention;

FIG. 22 illustrates a captured computer screen shot of the punchlist deck screen according to the present invention;

FIG. 23 illustrates a captured computer screen shot of the punchlist screen according to the present invention; and

FIG. 24 illustrates a captured computer screen shot of the close project screen according to the present invention.

### DESCRIPTION OF PREFERRED EMBODIMENTS

The present invention utilizes a three tiered system, also referred to as a cloud strata model. At the bottom is a public electronic library of product data for the supply chain cloud. In the middle sits the Electronic Data Plate as described herein, which functions to capture the relevant workflows. On top is the SC Collaborator, also referred to as the private clouds or project plate.

The Electronic Data Plate (EDP) carries, displays, and tracks packets (plates) of information as a series of mini-projects. This data can include tasks, items, resources, costs, and logistics. Whether listed as an accounting code or specification number, or a scene or a set number in a film production, the EDP can be used as a standalone product to capture the dataflow of a project or process, such as questions/answers, changes to original plans, calculations, budgeting, progress photographs, categories, end users, suppliers, submittals and review. In aggregate, the EDP system will deliver the macro view as well. The EDP will preferably have at a minimum of two plates; a top plate that captures and displays information of a micro task or item, and a bottom plate that externally links to the products and materials of the global (regional) supply chain. In an alternative embodiment, a pair of middle plates will be added to the EDP stack. The third plate will focus on green (environmentally friendly) codes, while the fourth plate will focus on purchase orders and logistics of the supply chain. When aligned, a series of EDPs will create a value chain regardless of the type of project or industry. The thin, flexible, versatile data plates will be placed by phase in an interactive, loose-layout format on a money-time (cost versus schedule) paradigm of a project or process. This will enable and empower the user to move, maneuver, and manipulate the project tasks, items, and products interactively across all the phases of a schedule to dynamically show the financial impact of decisions made on supply chain lag or scheduling bottlenecks. It will also provide a forecasting lens that will allow the user to run “what if” scenarios, so they can visualize progress, problems, and hot spots in terms of not only logistics and deliverables, but what the costs failover will be as a result of delays or other unseen, unanticipated issues that will impact the schedule.

The Electronic Data Plate is a color-coded, icon-driven, four-tier plate system. It is set in a Web-based or cloud-based software-as-a-service (SaaS) software solution model and displayed by value, resource, and schedule in a project or process tree. Each project tree is set on an interactive screen as a chain flow of information connected to and associated with one another in a sequence. Each EDP plate will capture information for a trade or task, pool the data as a series of mini-projects, and store and link all activities and items associated with the resource flow of elements in each task or operation. The graphical user interface shows the current status of the series of EDPs on a given project. A user will enter any review input in the selected EDP, and the result of the review will be a global display on the top plate by the color-coded system, providing an instant snapshot of the project status.

The EDP is a collaborative tool that can be shared in a private (project) cloud environment, from its information to the application of the software. Combined with loose-layout planning, the EDP can break down or build up the whole of a project by the sum of its parts as in subproject needs, milestones, and resources. The EDP will always be linked to other related items/tasks and the macro dependents of the project lifecycle, including the critical path items by cost and schedule. By sharing key data in a cloud “fishbowl” ecosystem, where all stakeholders can view progress and see problems in the supply chain, it will be the composition of the EDPs, combined with the ease-of-use, color-coding, intuitive and interactive interface that will give a consistent, unified look and experience, as well as drive efficiency from existing paper-laden, manual processes to real-time automation and active user intervention.

### Overview

This section provides a high-level overview of key CNBUILDER features, current and future development, and integration with SC COLLABORATOR. The cloud portal for CNBUILDER will be found in the preferred embodiment at www.cloudnician.com.

### Overall Flow

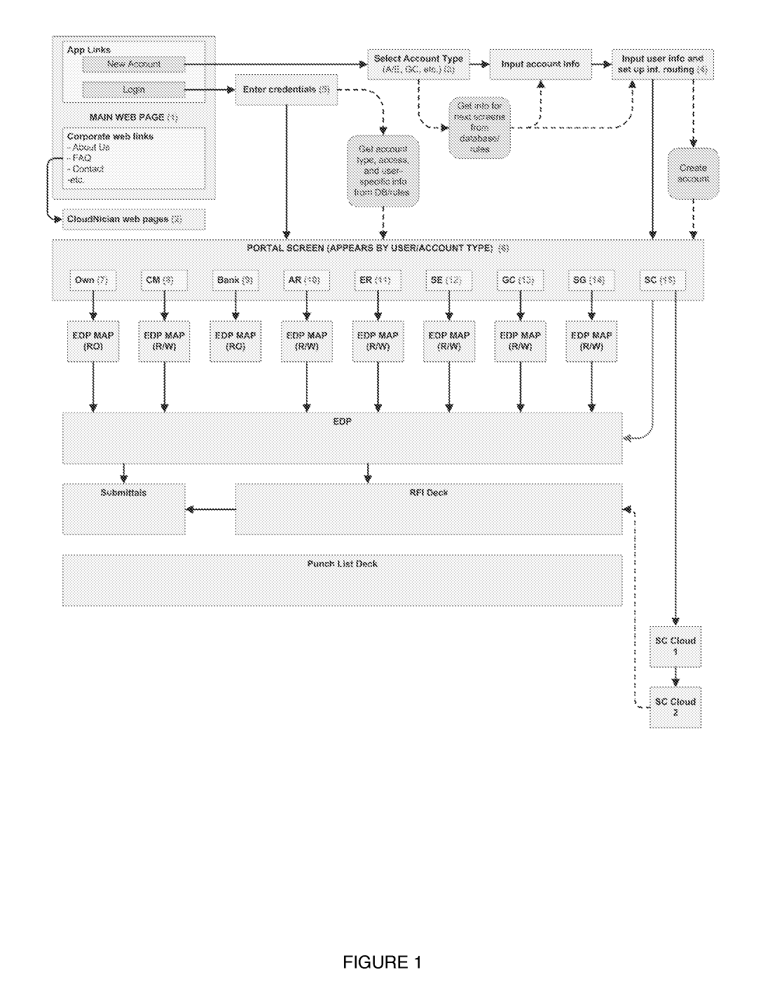

The overall CNBUILDER architecture is as shown in FIG. 1. The CLOUDNICIAN home page will include links to corporate web pages. These pages are web-based and beyond the scope of this application because they are not part of the CNBUILDER application. The CLOUDNICIAN home page will also have prominent links that allow existing users to login or new users to set up a new account.

### Account Types

CNBUILDER supports account types and customized functionality and access levels by project stakeholder. See the section below entitled Workflow Integration & Portal Screens for a list of supported account types.

### Security

New accounts are set up on a stakeholder-by-stakeholder basis. All of the authorized CNBUILDER users working for a particular stakeholder will receive login credentials through the stakeholder account. The CNBUILDER administrator within each organization will be responsible for adding/editing/removing users within that CNBUILDER account. This allows each account holder to specify authorized users within that account, specify user access levels within that account, and set up both default and project-by-project routing within the stakeholder account.

For example, a user within a subcontractor account may input and prepare a submittal that must then be approved and forwarded by someone else within that subcontractor. This ensures adequate controls within each CNBUILDER account. Project-specific settings may impact available functions. All users in all accounts will always be limited to the lesser of:

Special access privileges: for example, the Supply Chain does not normally have access to private project clouds; however, exceptions can be made as necessary to capture information about special/one-off products that are not generally available (such as stainless steel cladding panels made to custom shapes for a specific building).

Account-type access levels: a General Contractor will have different default access levels than a Subcontractor.

User-type access levels: often, a clerk may be able to input a submittal while only a project manager can approve and forward them.

User-level access: an individual user can only access those projects that s/he is working on or has worked on. For example, two project managers within a single stakeholder may not have access to the same projects within CNBUILDER.

Project-specific access: Architects and/or Construction Managers may set up information routing and review/approval requirements on a project-by-project basis to best serve the needs of that project.

CNBUILDER uses a unified login, which means that all valid CNBUILDER users within all valid CNBUILDER accounts can login using the single login button on the CLOUDNICIAN home page. Based on the credentials presented, the CNBUILDER application logic will automatically present the proper portal screen. (See below for Portal screen functionality by stakeholder.) A stakeholder can specify project-specific access (block access to one or more projects) to users within that account using the Edit User function in the Manage Account section of the Portal screen, and can also set up project-specific routing by designating users to Receive, Review, Approve, Reject, Edit, or Append submittals/RFIs/Punchlist items, etc. If an account does not specify project-specific routing on a project-by-project basis then all users within a given role will be able to perform that role for all active projects. For example, a project manager at a subcontractor who is allowed to review and forward submittals will be able to do this for all CNBUILDER projects to which the stakeholder has access, unless the CNBUILDER administrator blocks access to this privilege for one or more projects. Also, project-specific access terminates once the project is closed out. This highly flexible security architecture provides transparency for all stakeholders, reduces administrative overhead for small stakeholders, and also provides robust access and information control for larger stakeholders.

### Account Creation

All accounts are created through the New Account button on the CLOUDNICIAN home page regardless of type. The first New Account screen allows the new user to select one of the supported account types (discussed below). Once this selection is made, the next New Account Screens set up billing, default account options (such as job titles and internal routing for submittals, RFIs, etc.) and then to set up individual user roles and the users themselves. These settings will be the defaults for that account unless changed for a specific project.

### Unified Login

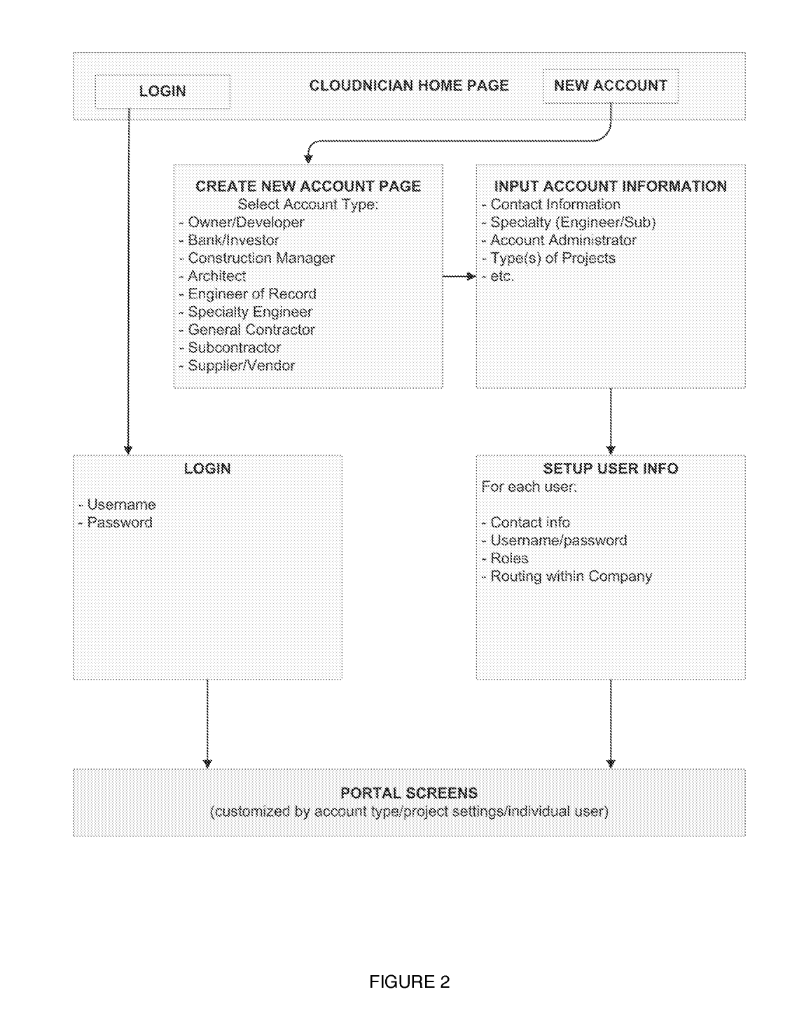

Clicking the Login button on the CLOUDNICIAN home page as shown in FIG. 2 and entering a valid username and password takes the user directly to the appropriate Portal screen with the default functions either enabled or disabled by access level as described above. CNBUILDER back-end application login automatically applies the proper logic.

### Portal Screens

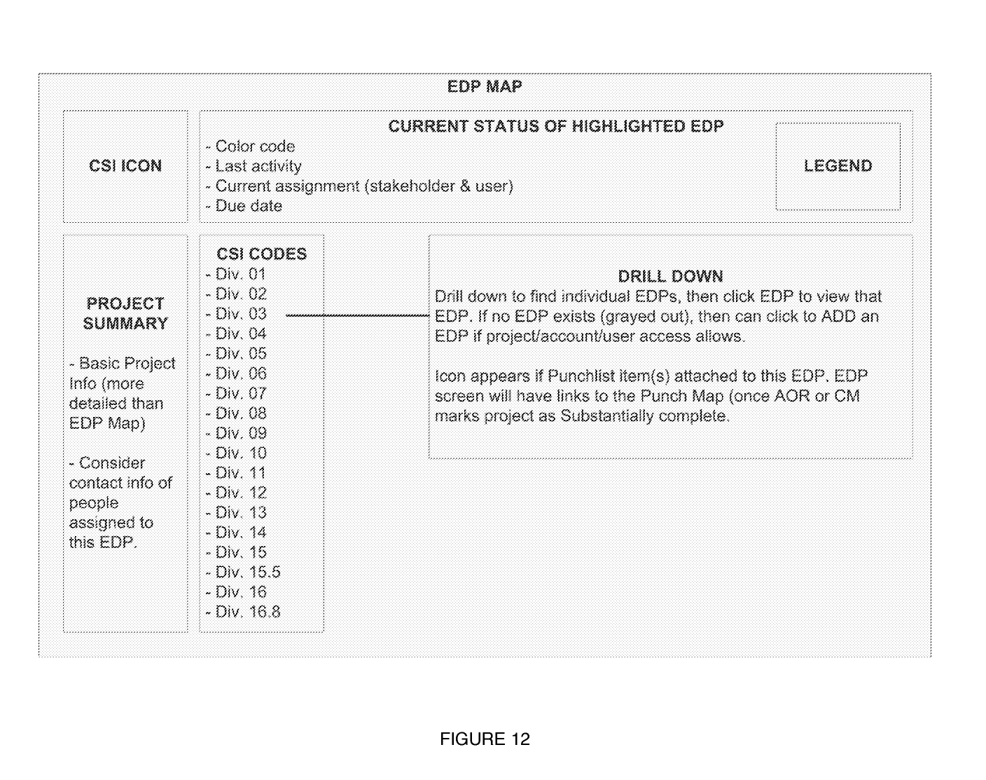

Once a user has logged in, the Portal screen serves as the starting point for all CNBUILDER functionality available to that user. The Portal screen lets the user quickly perform high-level functions. After selecting a project, the EDP Map (see FIG. 12) is the gateway to all information for a specific project while the Supply Chain Cloud is open to all users to find and add products and materials submittals information that are then transferred to the private project cloud.

### Unified Workflow

The CNBUILDER Portal screen and overall application architecture shown in FIG. 1 is designed to provide a unified experience for all stakeholders. This minimizes the learning curve for both new and existing users, particularly if users change roles within a stakeholder or go to work for a different stakeholder. For example, a project manager at a Subcontractor will be able to use CNBUILDER if he transfers to a General Contractor, Supply Chain vendor, or other stakeholder with no retraining needed.

### Development

This section describes current embodiment and planned functionality. CNBUILDER 1.0 addresses the largest issue facing project stakeholders, which is the workflow that consists of submittals, RFIs, and punchlist items. This focus on core issues will drive adoption by stakeholders and establish CNBUILDER as a construction management application utilizing a unique, intuitive, and easy-to-use interface. Alternative embodiments of CNBUILDER take advantage of the rapidly growing trend toward environmental awareness, green building practices, and sustainability in project design and construction to drive further adoption by delivering value to this expanding segment of the AEC industry. CNBUILDER incorporates logistics, resources, cost, and scheduling support to provide a true one-stop project management paradigm, whose functionality will be unique to the market. Project stakeholders currently employ separate teams of schedulers and estimators using applications such as PRIMAVERA and MICROSOFT EXCEL, respectively, who rarely sit in the same room long enough to know what the other is doing. Delivering end-to-end transparency across all stakeholders and functions will save time and money and drive improved project communications and efficiency.

Alternative embodiments of this invention add the following functionality:

LEED Visor that includes a green scorecard and materials sourcing, from raw and fabrication to delivery and installation.

Support a value chain of mini-projects in terms of budgets, costs, timelines, and logistics to facilitate detailed job costing.

Add scheduling functionality in an X-axis (time/schedule) and Y-axis (cost, budget) display, to empower project managers to see where potential bottlenecks will occur through the project, from design changes and long-lead item deliveries to detailed cost impacts caused by delays.

### SC Collaborator Integration

The SC Collaborator program is a framework across all key elements of a construction project from design, architecture, and engineering to contractor concerns regarding materials, budgeting, and scheduling with BIM software application used by both the design-build sides of a project. Because the EDP captures a project's workflow from bidding through closeout, it will center the SC Collaborator frame where the design specifications and BIM software will be housed.

### Workflow Integration & Portal Screens

CNBUILDER integrates into the existing construction project workflow as currently used by the stakeholders on construction projects. The stakeholders supported by CNBUILDER are the Owner/Developer, the Construction Manager, the Bank/Investor, the Architect of Record, the Engineer of Record, the Consultant/Specialty Engineer, the General Contractor, the Subcontractor, and the Supply Chain, as now described.

The Owner/Developer is responsible for obtaining the land on which to build the project, hiring the Architect-of-Record, participating in the bidding process, hiring the General Contractor, monitoring project progress, and responding to issues as they occur.

The Construction Manager (CM) is hired by the Owner/Developer as his representative. The CM is responsible for overseeing project progress and may participate in the bidding/hiring process. It is possible that the CM may take on some functions traditionally handled by the Architect of Record.

The bank and/or investor is responsible for providing project financing, hiring their own engineer(s) to review he design plans, monitoring project progress, managing their portfolio of projects, and approving progress payments for each project as they come due.

The Architect of Record (AOR) produces the final plans and specifications, pre-qualifies general contractors and participates in the bid process, may give input on subcontractors and supply chain stakeholders, hires the Engineer of Record and any specialty engineer(s) that may be needed, reviews/approves/rejects and responds to submittals, responds to RFIs, and may help review monthly payment requisitions. Some of these functions may be taken on by the CM on a project-by-project basis.

The Engineer of Record (EOR) is responsible for validating the project plans, reviewing and approving engineering-related submittals, and responding to RFIs.

The Consultant/Specialty Engineer is responsible for validating specific aspects of the project plans such as (but not limited to) acoustics, engineering, plumbing, structure, etc. S/he may review and respond to specialty engineering-related submittals, RFIs, etc.

The General Contractor (GC) is responsible for estimating project costs and schedules, bidding on projects, hiring subcontractors, preparing and forwarding submittals, generating and responding to RFIs as needed, developing the construction schedule, and overseeing the construction process.

The Subcontractors are responsible for estimating project cost and schedule within their own trades, bidding on projects, hiring lower-tier subcontractors, generating and forwarding submittals to the AOR/EOR/Owner, generating RFIs, and performing the actual construction work.

The supply chain consists of manufacturers, vendors, fabricators, etc. They are responsible for providing stock or custom materials, providing and/or fabricate products, delivering those materials and products, sending information on submittals, and responding to numerous product data queries from GCs and subs.

CNBUILDER integrates seamlessly into each stakeholder's workflow to deliver radical transparency and efficiency while eliminating redundancy and providing open accountability for/to all stakeholders. The following introduces the stakeholder Portal screens and provides a rough layout for each of them.

### Owner/Developer Workflow

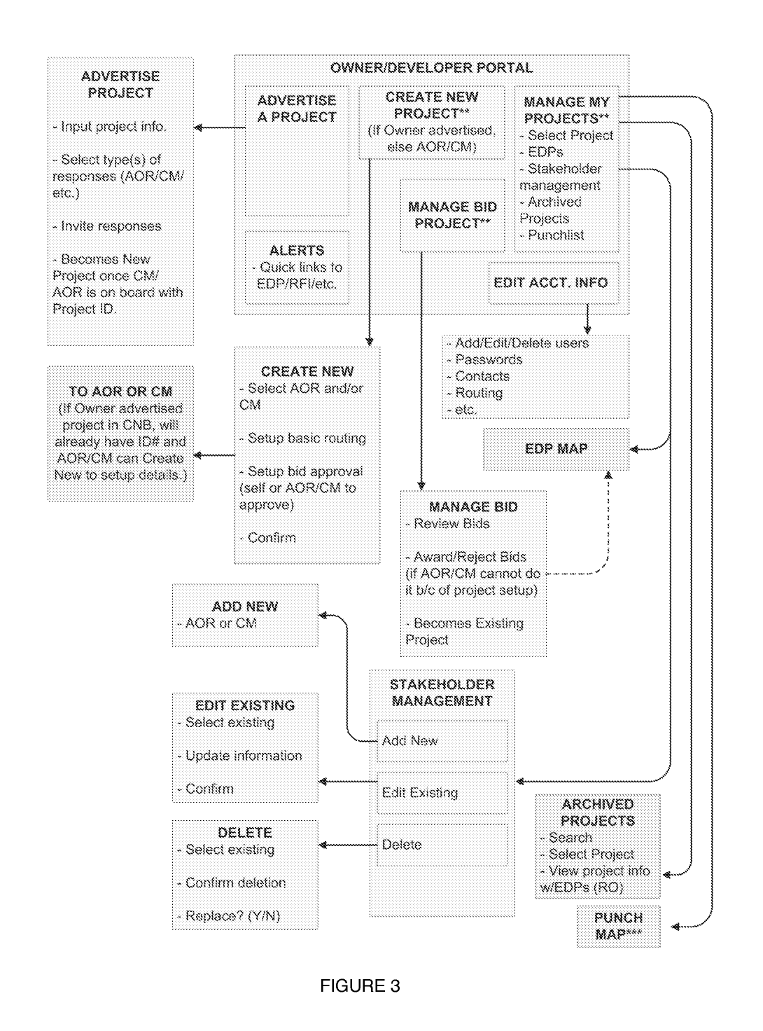

Owners/Developers who log into CNBUILDER have the default workflow available from the Owner/Developer Portal screen shown in FIG. 3.

The Advertise Project function is only available if the Owner has selected the option to advertise projects during account setup or subsequent update. The Create New Project and Manage Bid Project functions are only available if the AOR and/or CM are not handling or creating a new project in CNBUILDER. (This is not a usual situation.) The Punchlist option appears once the AOR or CM marks the project as substantially complete.

### Construction Manager Workflow

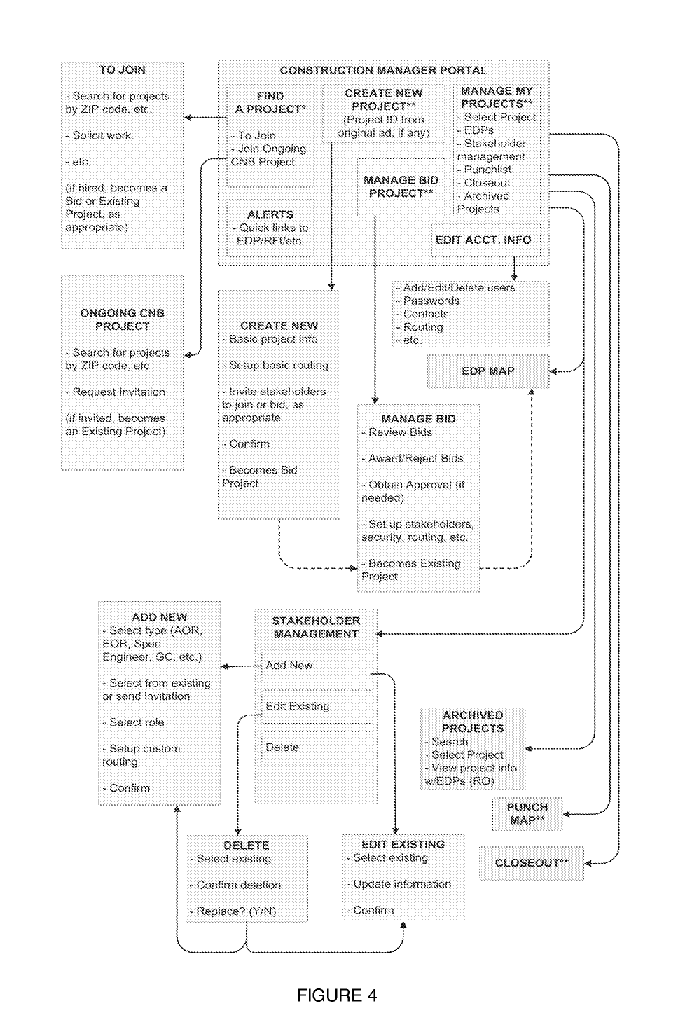

CMs who log into CNBUILDER have the default workflow available from the CM Portal screen shown in FIG. 4.

The Find a Project function only displays projects that are advertised by Owners/Developers. The CM can also create projects, if the AOR is not doing this.

The Create New Project and Manage Bid Projects functions are only available on projects where the AOR does not handle it. The Manage My Projects function is available but the CM may or may not be able to manage stakeholders depending on how an individual project is set up.

### Bank/Investor Workflow

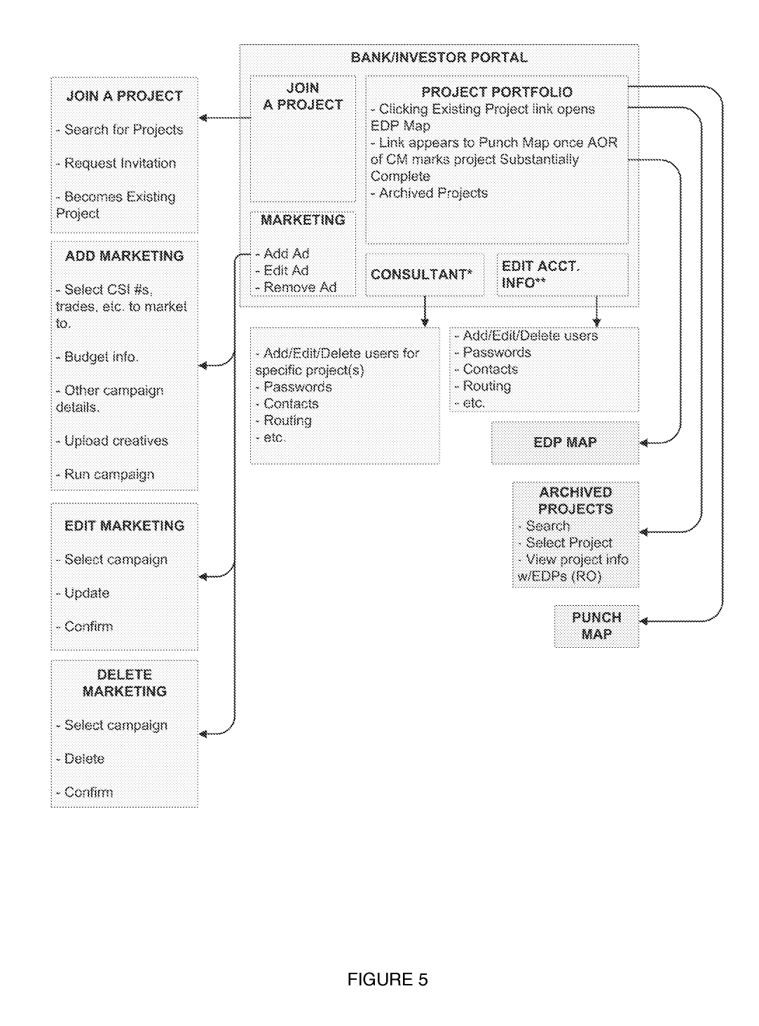

Bankers and investors who log into CNBUILDER have the following default workflow available from the Bank/Investor Portal screen shown in FIG. 5.

Banks and investors can bring in consultants who are external professionals such as engineers, members of the investor syndicate, etc. on a project-by-project basis. These consultants can view EDPs, specifications, submittals, RFIs, etc. but cannot add, edit, or remove any project information. These accounts become inactive when the project is closed out. There will be a Search feature in the Add User function to allow finding previously used professionals for future projects.

These are internal bank users whose routing and access privileges will remain constant from project to project unless a project is set up differently.

### Architect of Record Workflow

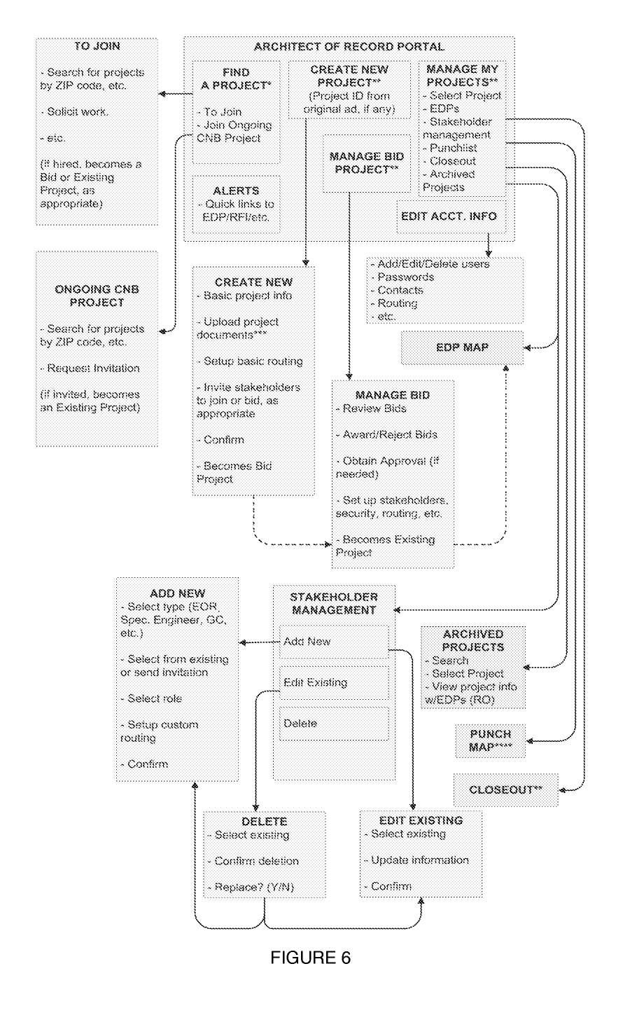

Bankers and investors who log into CNBUILDER have the following default workflow available from the architect of record (AOR) portal screen shown in FIG. 6.

The Find a Project function displays projects advertised by Owners/Developers and Construction Managers. AORs can also originate new projects, if not done by the CM.

Stakeholder and other management functions are only available on projects set up for the AOR to manage them (instead of the CM).

Functionality must be included to break out project documents (specs/plans/etc.) by CSI code. This can be either A) manual, or B) automatic with manual verification.

The Punch Map functions are available only after the AOR (or CM, depending on project setup) mark the project as substantially complete.

### Engineer of Record Workflow

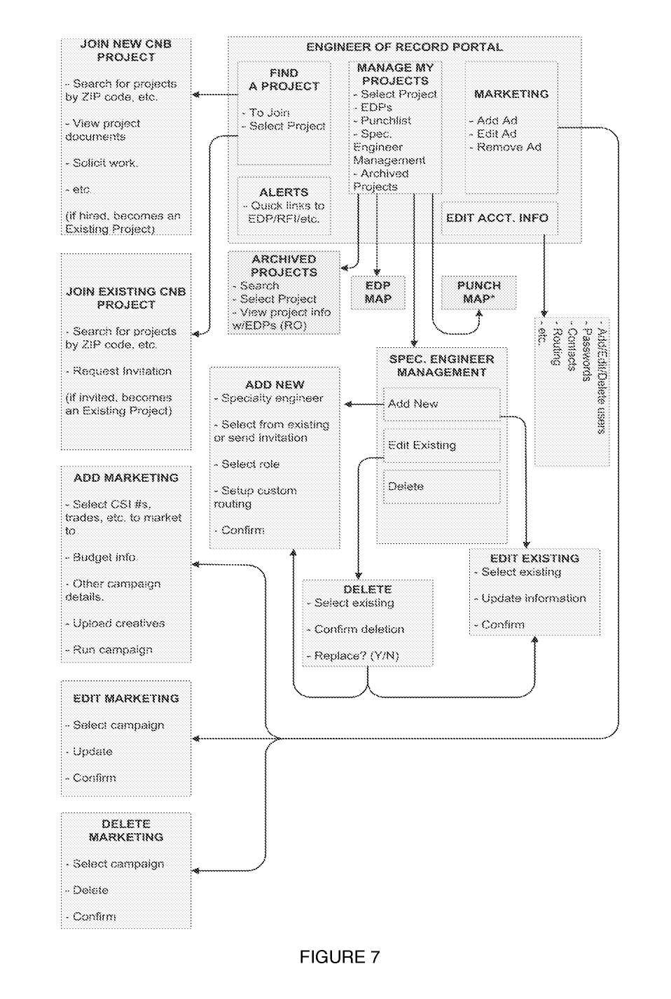

Engineers of Record who log into CNBUILDER have the following default workflow available from the EOR Portal screen shown in FIG. 7.

The Punch Map functions are available only after the AOR (or CM, depending on project setup) mark the project as substantially complete.

### Consultant/Specialty Engineer Workflow

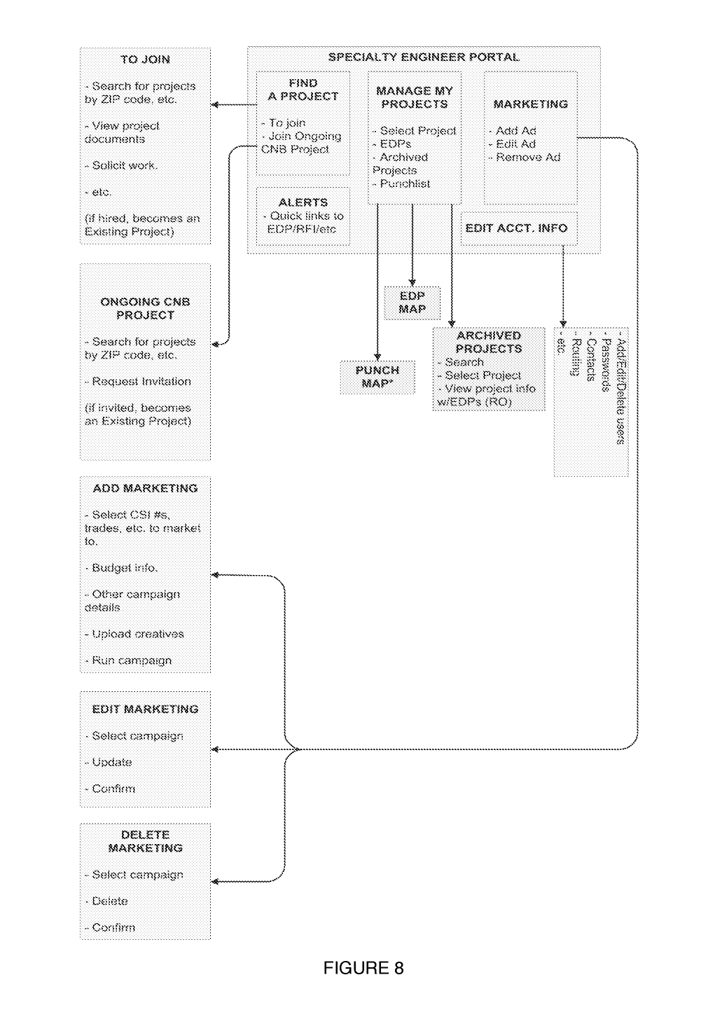

Consultant/Specialty Engineers who log into CNBUILDER have the following default workflow available from the Consultant/Specialty Engineer Portal screen shown in FIG. 8.

The Punch Map functions are available only after the AOR (or CM, depending on project setup) mark the project as substantially complete.

### General Contractor Workflow

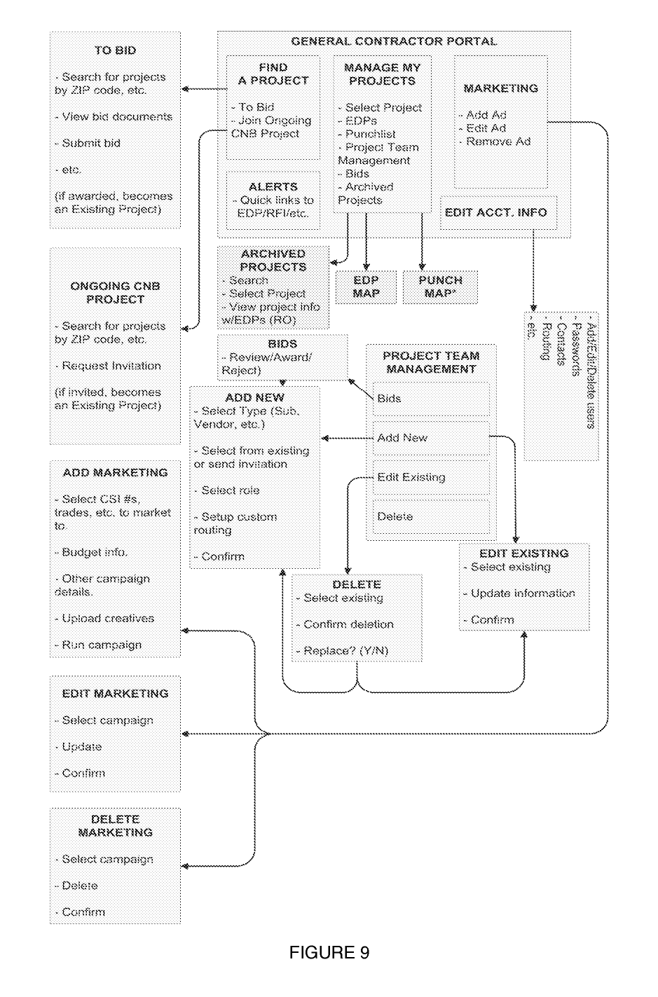

General Contractors who log into CNBUILDER have the following default workflow available from the General Contractor Portal screen shown in FIG. 9.

The Punch Map functions are available only after the AOR (or CM, depending on project setup) mark the project as substantially complete

### Subcontractor Workflow

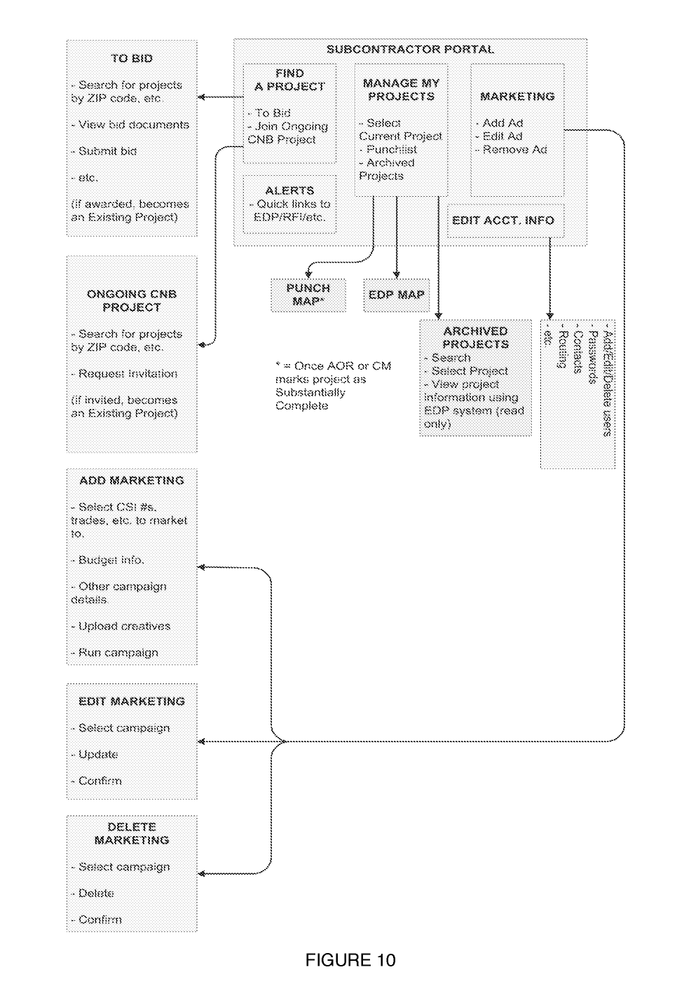

Subcontractors who log into CNBUILDER have the following default workflow available from the Subcontractor Portal screen shown in FIG. 10.

The Punch Map functions are available only after the AOR (or CM, depending on project setup) mark the project as substantially complete.

### Supply Chain Workflow

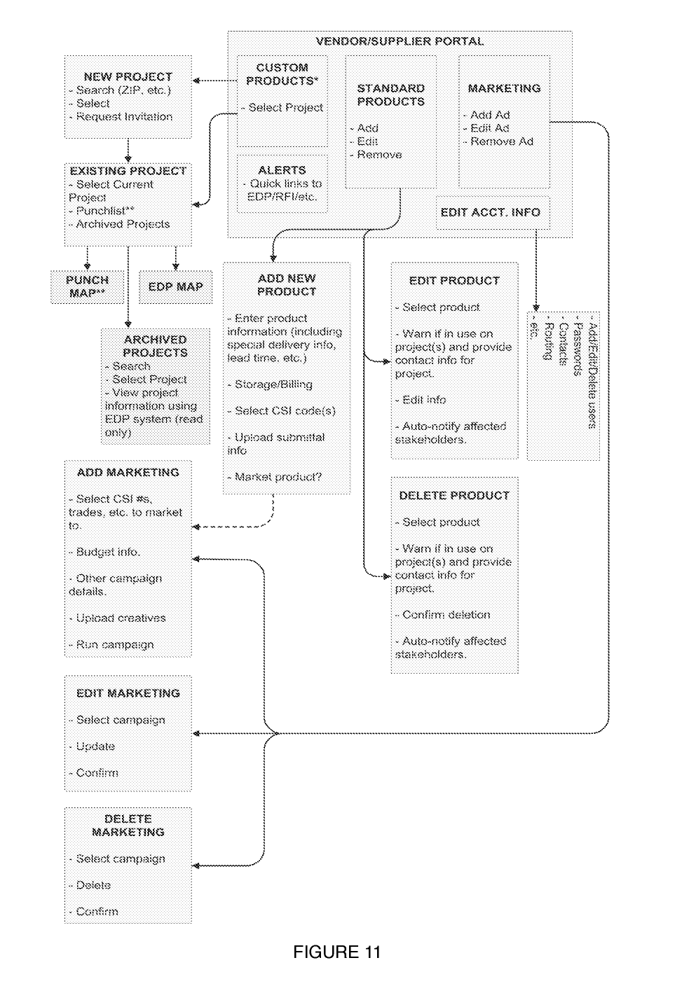

Supply chain members (vendors, manufacturers, suppliers, and fabricators) who log into CNBUILDER have the following default workflow available from the Supply Chain Portal screen shown in FIG. 11.

Custom products are those made for the first time where intellectual capital and/or patent concerns may preclude a vendor from placing this information on the public supply cloud, such as custom materials made for a specific project. In this case, the vendor can obtain special access to a private product cloud through the Custom Products section of the Supply Chain Portal screen, add submittals, and route them to the appropriate subcontractor. The subcontractor then routes the submittals as normal based on project setup.

The Punch Map functions are available only after the AOR (or CM, depending on project setup) mark the project as substantially complete.

### The EDP System

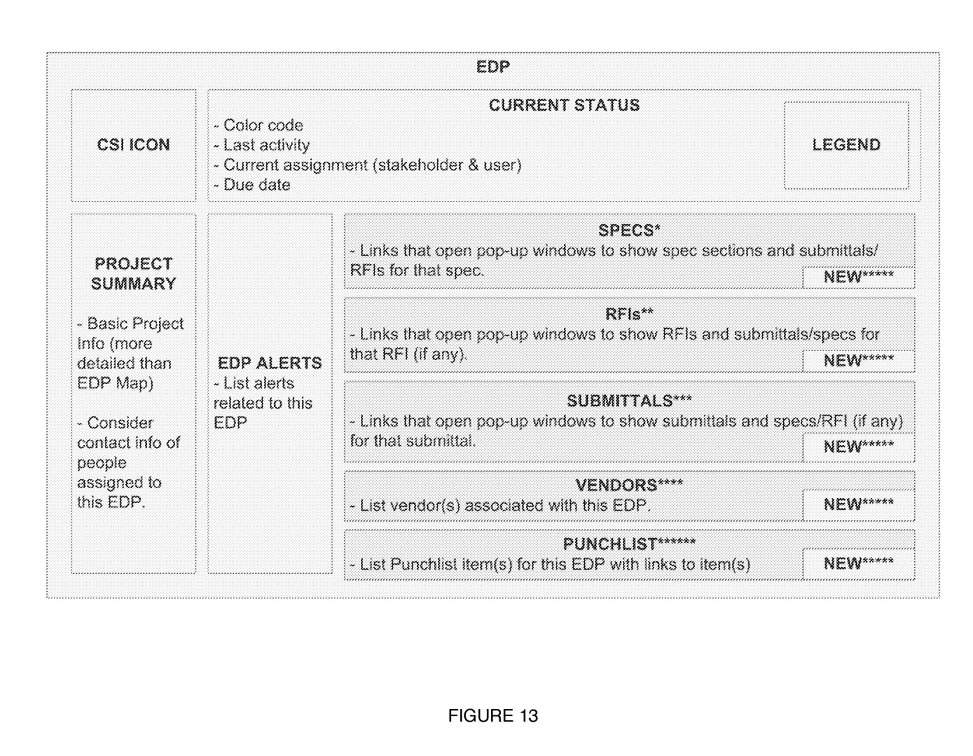

The EDP system in CNBUILDER will be built around the following two screens: the EDP Map as shown in FIG. 12 displays all EDPs for a project; and the EDP Screen as shown in FIG. 13 displays the selected EDP with links to the detail screens.

### EDP Map

The EDP Map screen is accessible to all stakeholders except vendors (unless a vendor has EDP access on a project-by-project basis). Clicking a CSI code opens a tree-based navigation system that allows the user to drill down to a specific EDP. All project EDPs are visible here. Users may be able to add/edit some or all EDPs based on account/user/project settings. For example, a subcontractor can view all EDPs but can only add/edit EDPs by trade specialty. The EDP Map screen is the main screen for either bidding or for monitoring and updating workflow activity on projects. CNBUILDER supports CSI codes from 010000 to 16800. Divisions that are not in use on a certain project (such as 14000 for elevators or escalators) will be either blank or grayed out. The project administrator (AOR or CM) may be able to edit the appearance of divisions that are not in use.

The CSI codes on the EDP Map screen will be color-coded. For example:

Grey=Not Submitted

Purple=Under Review

Dark Green=“Go” (approved, reviewed & approved, no exceptions taken)

Lime Green=Approved as Noted (marked up as noted)

Orange=Revise & Resubmit

Red=“Stop” or Rejected

Sky Blue=Not Reviewed

Each top-level CSI code will show the color of the most urgent update within that division. For example, if a submittal for CSI code 14250 has been rejected, then the 14000 entry on the EDP Map will appear red. Clicking the 14000 link opens a horizontal branch with a list of all of the top-level 14nnn entries within that division. In this example, the 14100 and 14300 links will appear colored according to the most urgent EDPs within those divisions while the 14200 link will be red. Clicking the 14200 link will open the EDPs under that subdivision and provide a link to all 14nnn EDPs, including the red 14250 EDP. If there are multiple EDPs for a single CSI number, there will be separate links to each EDP. For example, if there are two EDPs for CSI 14250 then the EDP Map screen will show two links to separate 14250 EDP screens. Each EDP will contain the specifications, submittals, RFIs, vendors, and any punchlist items for that EDP by hat project. For instance in Div. 9 “Finishes,” the branch might show a dozen EDPs with CSI numbers. The top-level CSI code will display a progress bar that shows the number of approved submittals versus the total number of submittals for that division. For example, if CSI 09000 has 15 submittals and 5 of those have been approved, the progress bar will show 5 of 15 approved. This bar will increment as additional submittals are approved in CSI 09000. Clicking a top-level CSI code expands that box to display three progress bars. The top bar shows the total number of submittals received for that division. The second shows the total number of approved submittals. The third shows the total number of rejected submittals. For example, if CSI 09000 has 15 submittals of which 8 have been received, 5 have been approved, and 3 have been rejected, the progress bars will show the following:
Top bar: 8 of 15
Middle bar: 5 of 15
Bottom bar: 3 of 15

The second-level CSI codes will also display single progress bars as described for the top-level CSI showing the total number of approved submittals. For example, if CSI code 09100 has 3 submittals and 2 have been approved, the progress bar for CSI 09100 will show 2 out of 3 approved. Clicking a second-level CSI code expands the progress bars to show the total number of submittals for that division, total submittals approved in that division, and total submittals rejected in that submittal as described above. The same thing happens at third-level CSIs (such as 09150).

Not all punchlist items correspond to an EDP. These items will be accessible in a separate Punchlist Deck screen that is available from the Portal screen.

### EDP Screen

Clicking an EDP (CSI #) in the EDP Map screen opens the detailed EDP screen of FIG. 13 that displays information about the selected EDP and allows the user to access and add/edit detailed information pertaining to that EDP. The EDP screen displays the following information:
CSI Icon: Representative icon by trade specialty. For example, the plumbing icon might show a drip of water or a pipe
Current Status: This section displays the EDP color code as well as the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific EDP.
Alerts: Displays automated information such as due dates, RFIs, etc. and may also display notes entered by a stakeholder.

The main portion of the EDP will provide access to Decks for Specifications, RFIs, Submittals, Vendor(s), and Punchlist items (job-specific) related to that EDP.

If there is no related item in one or more areas (such as if no submittals have been added for this EDP) then the related area will be blank except that users will be able to add a new item if they have the proper access level.

Each area will have a New button that allows the user to add new information (if that user has proper access privileges). Other functions are available from Decks and/or detail screens.

### Decks and Detail Screens

All Deck screens are available from the EDP screen.

### Spec Deck

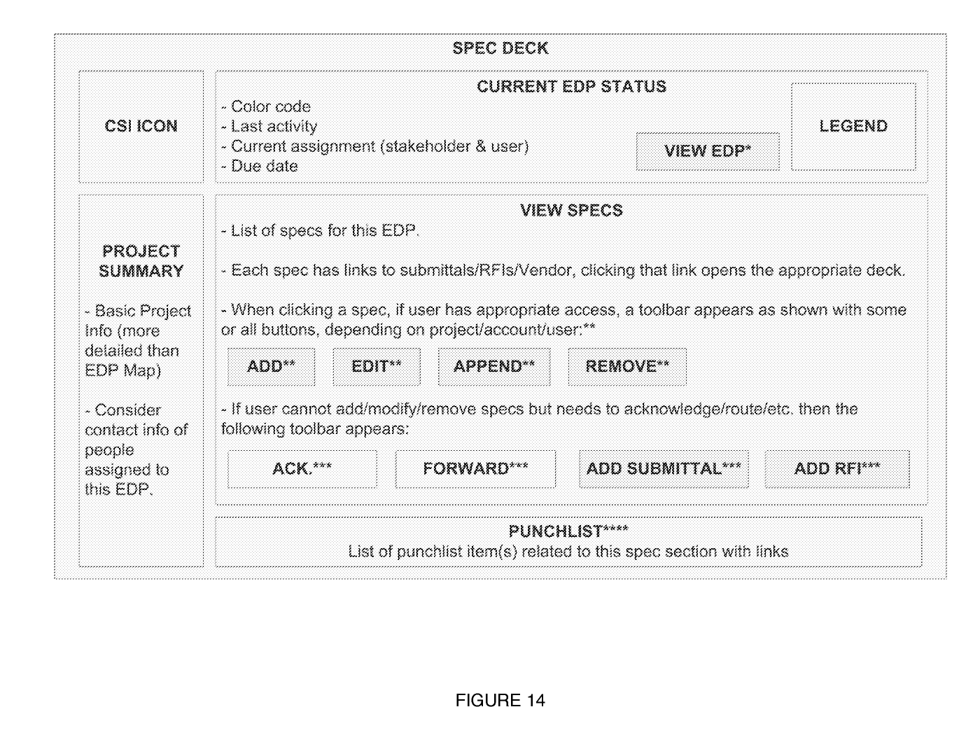

The Spec Deck screen of FIG. 14 contains all of the specifications for the selected EDP and displays the following information:

CSI Icon: Representative icon by trade specialty. For example, the plumbing icon might show a drip of water or a pipe

Current Status: This section displays the EDP color code as well as the date of last activity, the currently assigned stakeholder and user within that stakeholder, and when the next action is due.

Project Summary: Lists basic project info and contact information for the currently assigned stakeholder/user. This will include the name, project number, owner, architect, contractor, and all their contact information, as well as any subcontractor/vendor(s) for this specific EDP.

View Specs: Opens the Spec screen for the selected spec.

Punchlist: List of punchlist items for this spec, if any. Clicking a link opens the Punchlist Deck screen (once project marked as substantially complete). The screen contains access to the following functions by account/user/project settings:

View EDP: Returns to EDP screen.

Add: Add a new specification. Opens a blank Spec screen allows adding information.

Edit: Edit an existing specification. Opens selected Spec screen and allows edits.

Append: Opens selected Spec screen to allow edits but does not allow modifying existing information; only new information may be added.

Acknowledge: Acknowledge receipt/viewing specification.

Forward: Assign the selected specification to another user (such as a new architect at the AOR firm)

Add Submittal: Allows the GC or Subcontractor to add a submittal.

Add RFI: Allows stakeholder to add an RFI.

### Spec Screen

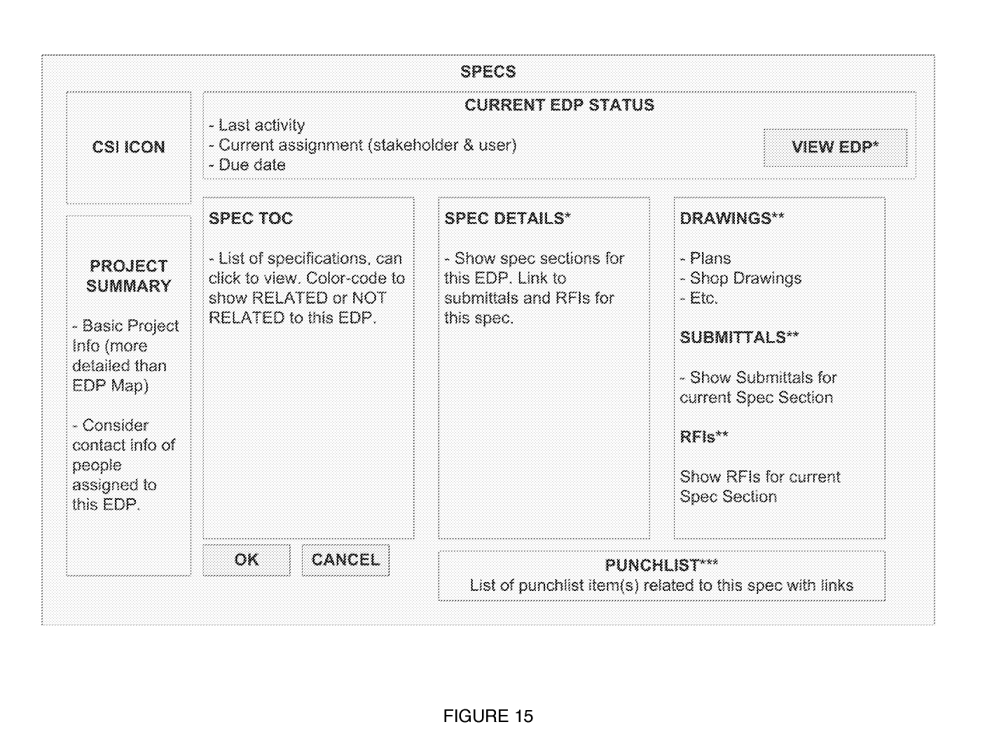

Clicking a link on the Spec Deck screen of FIG. 14 opens the Spec screen of FIG. 15, which shows detailed information about the selected specification:
CSI Icon: Representative icon by trade specialty. For example, the plumbing icon might show a drip of water or a pipe.
Current Status: This section displays the current status for the selected spec, including the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific submittal.
Spec TOC: Color-coded specification table of contents.
Spec Details: Describes the specification in detail.
Additional Information: Drawings, submittals, RFIs, etc. related to this spec.

This screen has the following functions depending on the link clicked from the Spec Deck screen:
Add: The Spec screen is blank to allow adding information. Links to search for products/vendors, add custom info, etc.
Edit: The existing submittal information is presented in the Spec screen for editing.
Append: The existing submittal item information is presented in the Spec screen. Additional information can be added, but existing information cannot be modified.

### RFI Deck

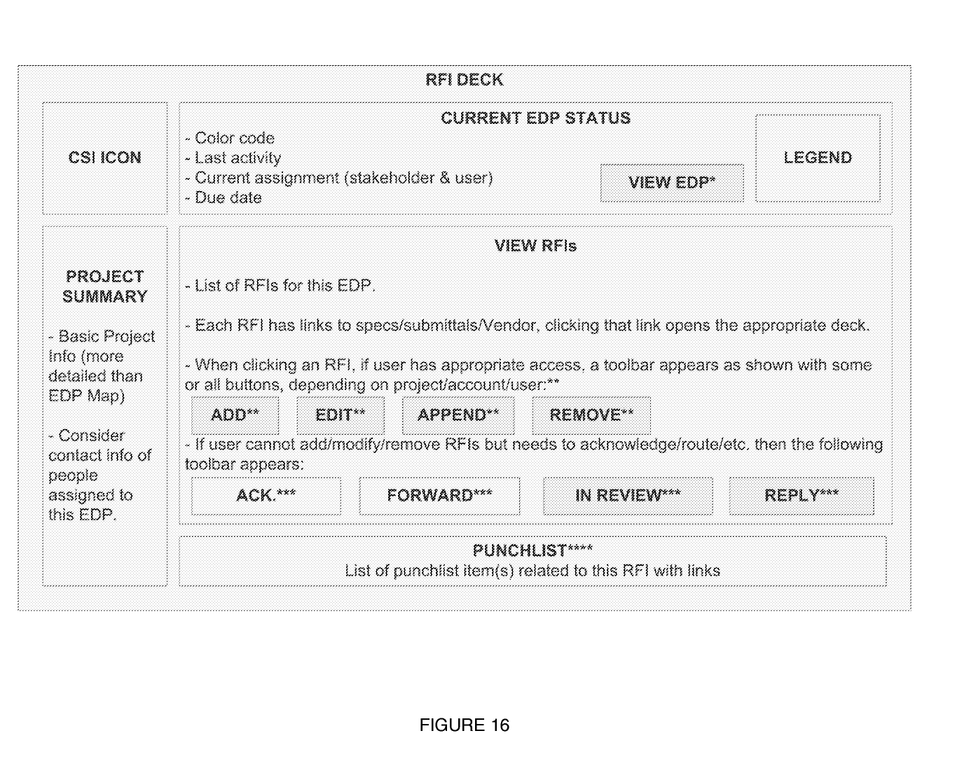

The RFI Deck screen of FIG. 16 contains all of the RFIs for the selected EDP and displays the following information:
CSI Icon: Representative icon by trade specialty. For example, the plumbing icon might show a drip of water or a pipe.
Current Status: This section displays the EDP color code as well as the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific EDP.
View RFI: Opens the RFI screen for the selected RFI.
Punchlist: List of punchlist items for this EDP, if any. Clicking a link opens the Punchlist Deck screen (once project marked as substantially complete).

This screen contains access to the following functions by account/user/project settings:
View EDP: Returns to EDP screen.
Add: Add a new RFI. Opens a blank RFI screen and allows adding information.
Edit: Edit an existing RFI. Opens selected RFI screen and allows edits.
Append: Opens selected RFI screen to allow edits but does not allow modifying existing information; only new information may be added.
Remove: Removes the RFI and logs the removal (if, for example, the RFI was entered in error)
Acknowledge: Acknowledge receipt/viewing RFI.
Forward: Assign the selected RFI to another user (such as a new architect at the AOR firm)
In Review: Indicates that the RFI is under review.
Reply: Opens the RFI screen for the selected RFI with the Answer area ready to capture reply to the selected RFI.

### RFI Screen

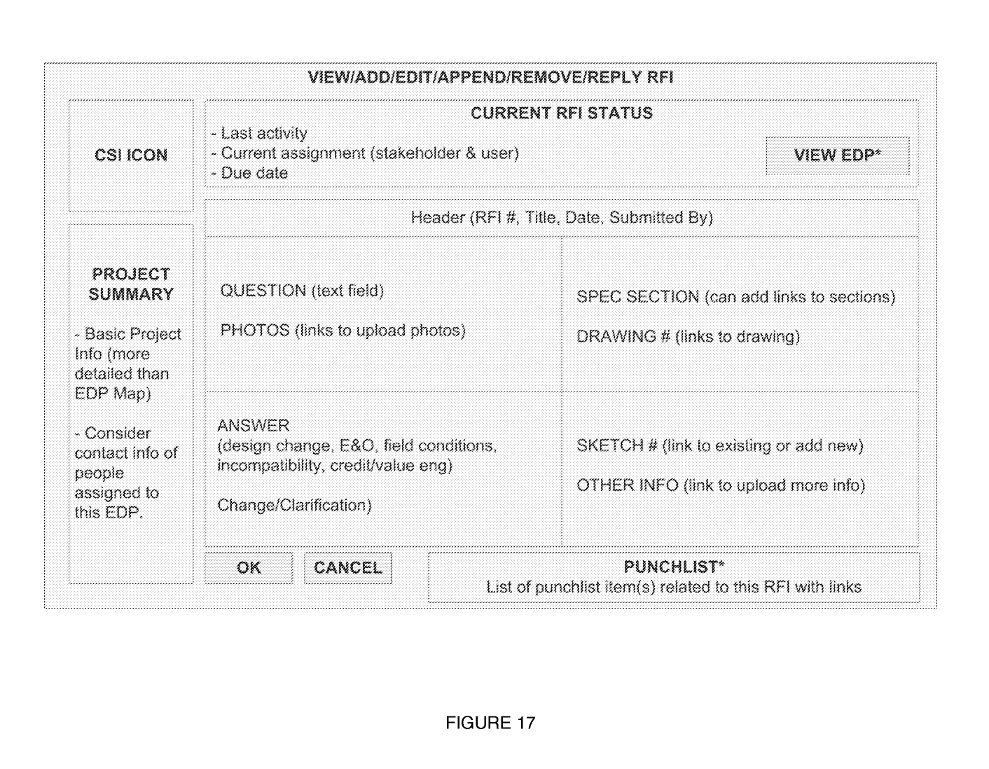

Clicking a link in the RFI Deck screen of FIG. 16 opens the RFI screen of FIG. 17, which shows detailed information about the selected RFI:
CSI Icon: Representative icon by trade specialty. For example, the plumbing icon might show a drip of water or a pipe.
Current Status: This section displays the current status for the selected RFI, including the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific RFI.
RFI Header: Item #, title, date, and who submitted this item.
Question: Describes the question and includes photos as well as functions to add photos to this item.
References: References to spec section, drawing number, submittal, RFI, and/or subcontractor and vendor. Not all RFIs correspond to all of these items.
Answer: Lists the answer to this RFI; includes functions to add photos.
Sketch/Other Info: Can add a sketch or link, plus other information if needed, and/or for ongoing dialogue between stakeholders.

This screen has the following functions depending on the link clicked from the Punchlist Deck screen:
Add: The RFI screen is blank and allows adding information.
Edit: The existing RFI item information is presented in the RFI screen for editing.
Append: The existing RFI item information is presented in the RFI screen. Additional information can be added, but existing information cannot be modified.

### Submittals Deck

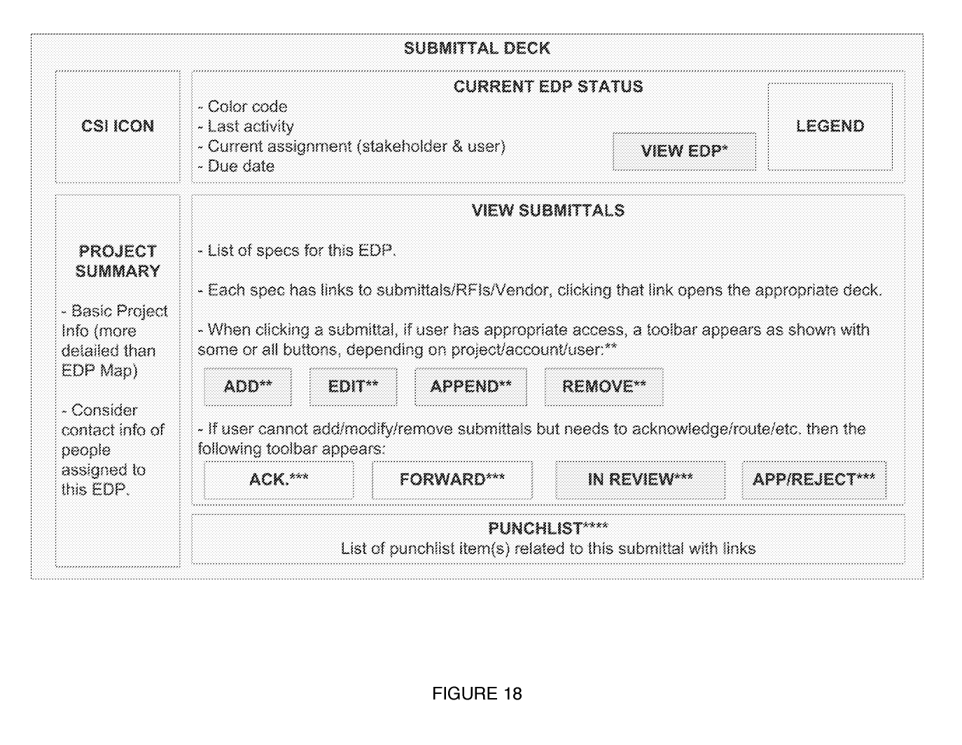

The Submittals Deck screen of FIG. 18 contains all of the submittals for the selected EDP and displays the following information:
CSI Icon: Representative icon by trade specialty. For example, the plumbing icon might show a drip of water or a pipe
Current Status: This section displays the EDP color code as well as the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific EDP.
View Submittals: Opens the Submittal screen for the selected submittal.
Punchlist: List of punchlist items for this submittal, if any. Clicking a link opens the Punchlist Deck screen (once project marked as substantially complete).

This screen contains access to the following functions by account/user/project settings:
View EDP: Returns to the EDP screen.
Add: Add a new submittal. Opens a blank Submittal screen and allows adding information.
Edit: Edit an existing submittal. Opens selected Submittal screen and allows edits.
Append: Opens selected Submittal screen to allow edits but does not allow modifying existing information; only new information may be added.
Remove: Removes the submittal and logs the removal (such as if the submittal was entered in error)
Acknowledge: Acknowledge receipt/viewing submittal.
Forward: Assign the selected submittal to another user (such as a clerk who enter the submittal and forwards it to a manager at the subcontractor firm)
In Review: Indicates that the submittal is under review.
Approve/Reject: Allows the ARO/EOR/etc. to indicate approval as-is, approval as noted, or rejection of the submittal.

### Submittal Screen

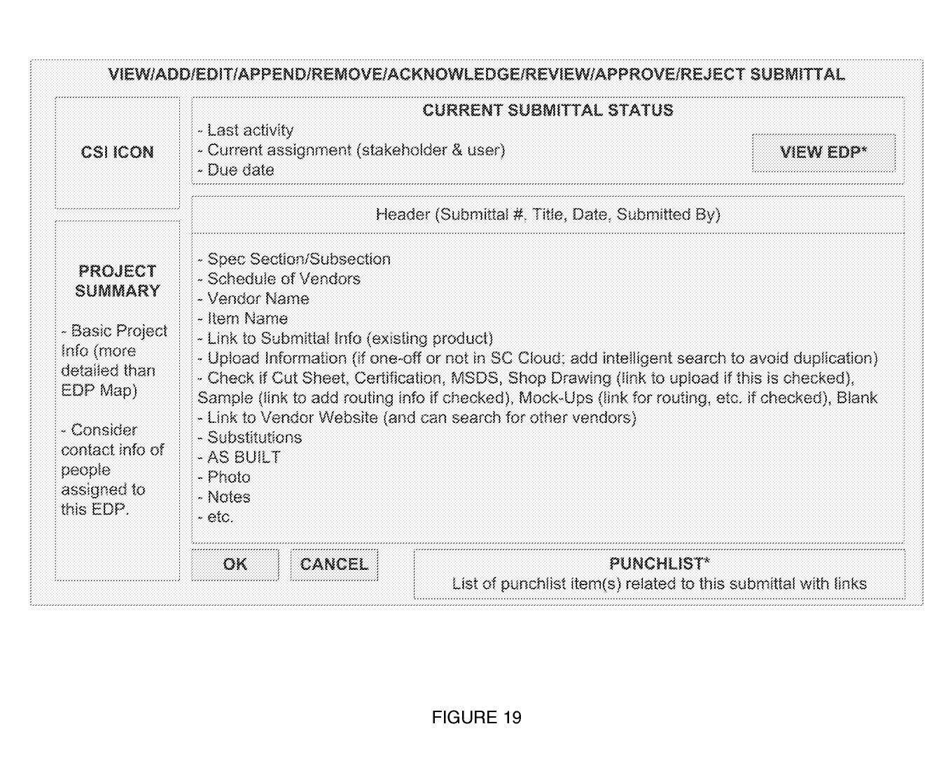

Clicking a link in the Submittals Deck of FIG. 18 screen opens the Submittal screen in FIG. 19, which shows detailed information about the selected submittal:
CSI Icon: Representative icon by trade specialty. For example, the plumbing icon might show a drip of water or a pipe.
Current Status: This section displays the current status for the selected submittal, including the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific submittal.
Submittal Header: Item #, title, date, and who submitted this item.
Detailed Information: Describes the submittal in detail, with possible links to photos, datasheets, etc. as shown here.

This screen has the following functions depending on the link clicked from the Submittal Deck screen:
Add: The Submittal screen is blank and allows adding information. Links to search for products/vendors, add custom info, etc.
Edit: The existing submittal information is presented in the Submittal screen for editing.
Append: The existing submittal item information is presented in the Submittal screen. Additional information can be added, but existing information cannot be modified.

### Vendor Deck

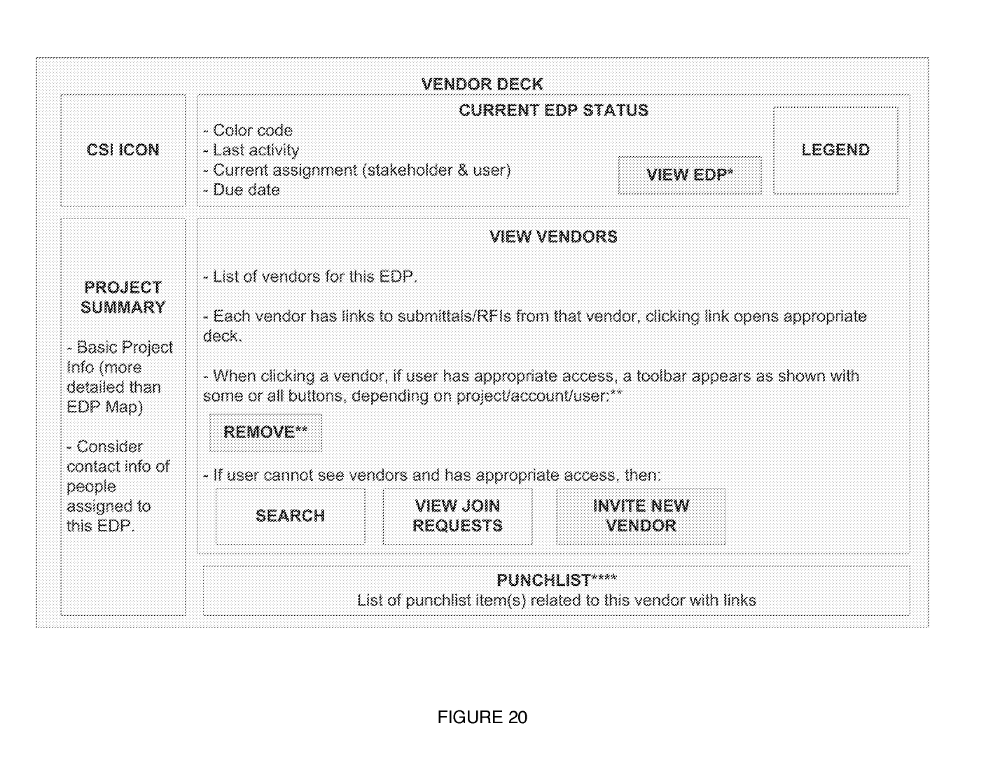

The Vendor Deck screen of FIG. 20 contains all of the vendors for the selected EDP and displays the following information:
CSI Icon: Representative icon by trade specialty. For example, the plumbing icon might show a drip of water or a pipe.
Current Status: This section displays the EDP color code as well as the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific EDP.
View Vendors: Opens the Vendor screen for the selected submittal.
Punchlist: List of punchlist items for this EDP, if any. Clicking a link opens the Punchlist Deck screen (once project marked as substantially complete).

This screen contains access to the following functions by account/user/project settings:
View EDP: Returns to EDP screen.
Remove: Removes selected vendor from project and triggers alert to stakeholders.
View Join Requests: View vendors who have requested access to the currently selected CNBUILDER project.
Invite New Vendor: Invite a vendor to join the project (such as during stakeholder transition) and/or invite a new vendor to create a CNBUILDER account.

### Vendor Screen

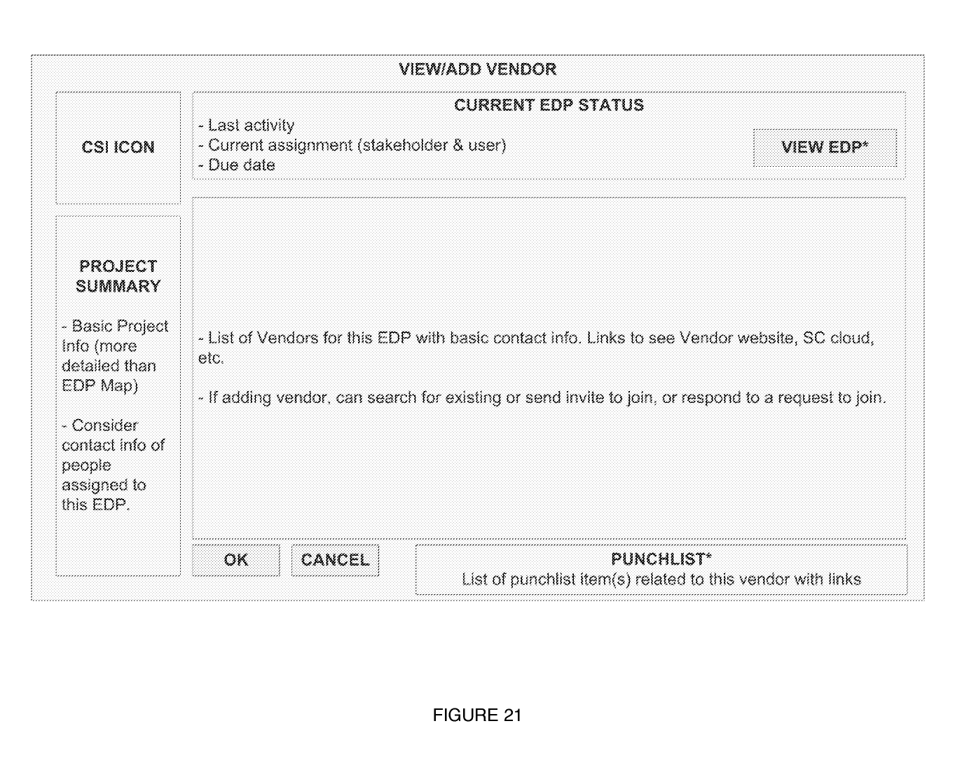

Clicking a View Vendor link (or a link in the Vendor Deck screen) opens the Vendor screen of FIG. 21, which shows detailed information about the selected vendor (supply chain):
CSI Icon: Representative icon by trade specialty. For example, the plumbing icon might show a drip of water or a pipe.
Current Status: This section displays the current status for the EDP(s) associated with the current vendor including the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific EDP.
Vendor Details: Detailed vendor information for he currently selected vendor.

This screen has the following functions depending on the link clicked from the Vendor Deck screen:
Edit: If editing a vendor, clicking that vendor allows one to edit that vendor info (such as access level, etc.) for the current project/EDP/etc.
Remove: If removing a vendor, clicking a vendor displays a confirmation and then removes that vendor.
Add/Invite: If adding a vendor, can search for an existing CNBUILDER account or can create an invitation to join CNBUILDER. User can also view join requests and select vendors if previously invited.

### Punchlist Deck

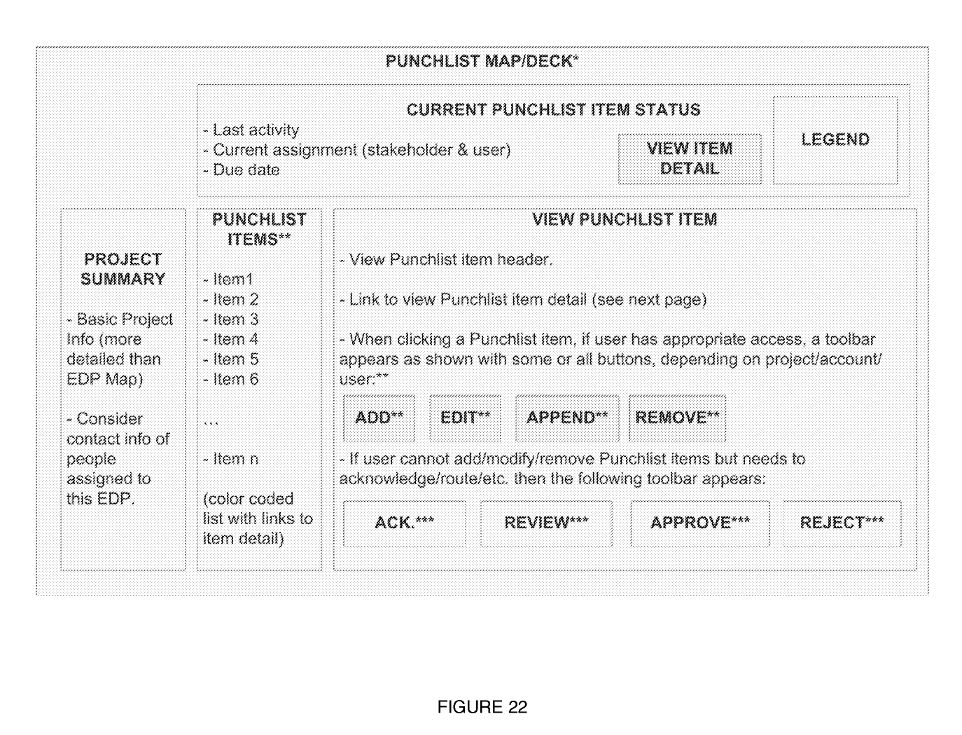

The Punchlist Deck screen of FIG. 22 contains all of the punchlist items for the selected project. This screen is available once the AOR or CM marks the project as substantially complete. Punchlist items may be, but are not necessarily, associated with specs, submittals, RFIs, and/or vendors. This screen displays the following information:
Current Status: This section displays the current status for the highlighted punchlist item, including the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific punchlist item.
Punchlist Items: List of all punchlist items. Clicking one opens a summary of that in the View Punchlist Item section.
View Punchlist Item: Displays header of the highlighted punchlist item.

This screen contains access to the following functions by account/user/project settings:
Add: Add a new punchlist item. Opens a blank Punchlist screen and allows adding information.
Edit: Edit an existing punchlist item. Opens selected Punchlist screen and allows edits.
Append: Opens selected Punchlist screen to allow edits but does not allow modifying existing information; only new information may be added.
Remove: Removes the punchlist item and logs the removal (if, for example, the item was entered in error).
Acknowledge: Acknowledge receipt/viewing punchlist item.
Review: Review punchlist item for satisfactory completion.
Approve/Reject: Allows the ARO/EOR/etc. to indicate approval or rejection of the punchlist item.

### Punchlist Screen

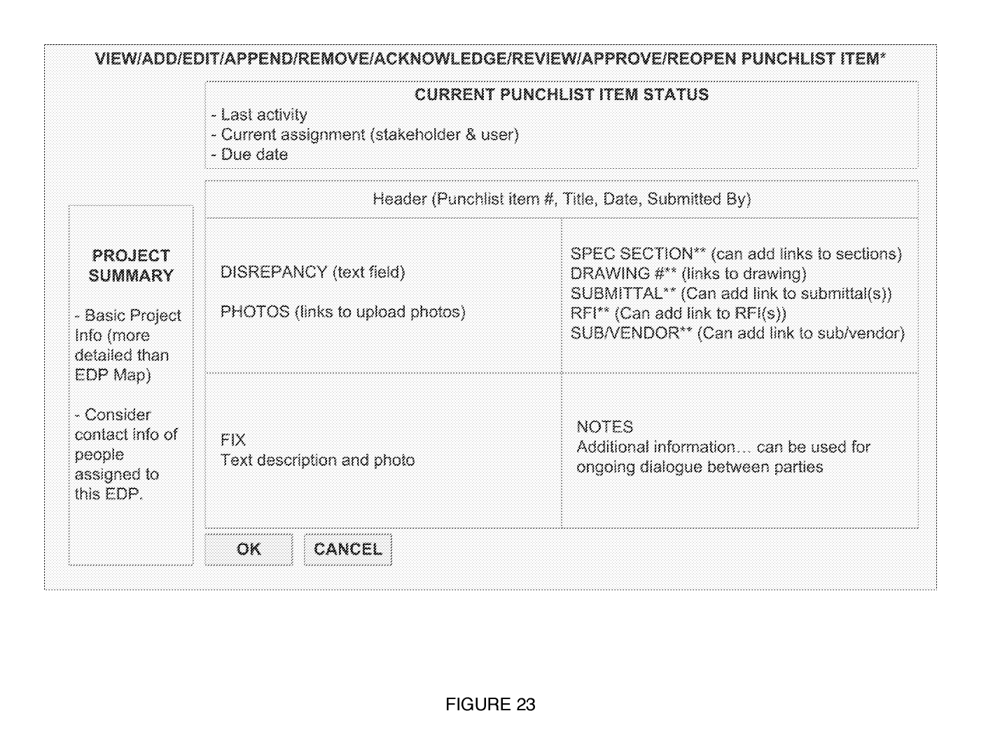

Clicking a link in the Punchlist Deck screen opens the Punchlist screen of FIG. 23, which shows detailed information about the selected punchlist item:
Current Status: This section displays the current status for the selected punchlist item, including the date of last activity, the currently assigned stakeholder and user within that stakeholder, and when the next action is due.
Project Summary: Lists basic project info and contact information for the currently assigned stakeholder/user. This will include the name, project number, owner, architect, contractor, and all their contact information, as well as any subcontractor/vendor(s) for this specific punchlist item.
Punchlist Header: Item #, title, date, and who submitted this item.
Discrepancy: Describes the discrepancy and includes photos as well as functions to add photos to this item.
References: References to spec section, drawing number, submittal, RFI, and/or subcontractor and vendor. Not all RFIs correspond to all of these items.
Fix: Lists fixes done to address this item and includes functions to add photos.
Notes: Can add additional information if needed, and/or for ongoing dialogue between stakeholders.

This screen has the following functions depending on the link clicked from the Punchlist Deck screen:
Add: The Punchlist screen is blank to allow adding information.
Edit: The existing punchlist item information is presented in the Punchlist screen for editing.
Append: The existing punchlist item information is presented in the Punchlist screen. Additional information can be added, but existing information cannot be modified.

### Close Project Screen

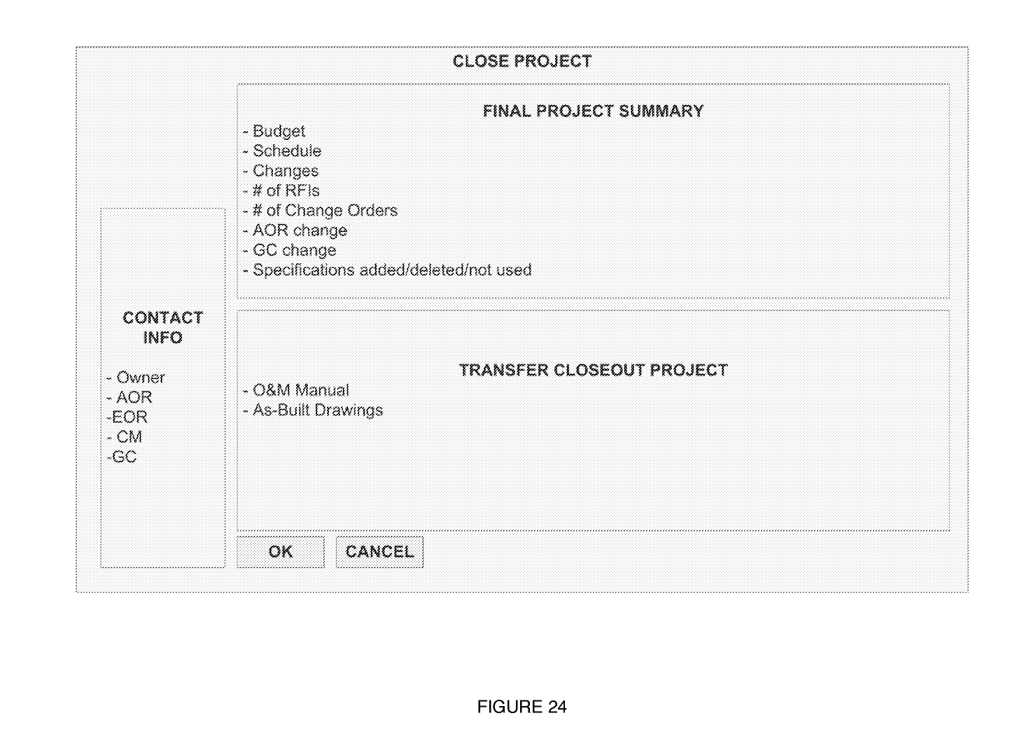

The Close Project screen of FIG. 24 allows the AOR or CM (depending on project setup) to upload final documents and close the project, which then moves to the Archived Projects section of stakeholder Portal screens. The Close Project screen displays the following information:
Contact Info: Lists basic contact information for the major project stakeholders.
Final Project Summary: This section displays the budget, schedule, number of changes, number of RFIs, number of change orders, and other final project summary information.
Closeout Project: Allows AOR or CM to upload final documents and close out the project.

### Reporting and Logging

This section outlines the reporting and logging functionality that is included in CNBUILDER.

### Archiving

CNBUILDER will log all archived project data, including changes to documents.

### Reporting

CNBUILDER includes the following reports:

RFI Deck:
RFI List—(in its entirety at the point of time)
RFI Deck—(individually, or for a specification, or a CSI Division, or the entire job)
RFI Photos within the Deck (by each RFI deck)

Punch List:
PL Report (list)
PL Deck
PL Photos

Submittals:
EDP Plate by CSI Code (top & bottom—like a print screen function)
Threaded Notes within individual EDPs, which will give history of the dialogue (instead of 30-50 emails per spec, 1-2 pages of Notes)
Status Report (A/E review) by 1) Approved, 2) Approved As Noted, 3) Revise & Resubmit, 4) Rejected, 5) Not Submitted, 6) Other
Snap Shot (again print screen of the global status for an entire project at any given time)
Submittal Log(which will include design specifications vs. GC substitution products)

### Logging

CNBUILDER logs all of the following events:
New Account creation
Stakeholder adds, edits, removals
All project-specific settings w
Account deletion
All user adds/edits/removals
All logins, durations, logouts, which screens were visited, what info was added/removed/etc. to where an investigation will be able to assemble a complete forensic history of absolutely everything that every user has done in the system on a user, account, and project-level basis.
All project documents added, appended, edited, deleted, reviewed, approved, etc. as well as detailed routing information (who had it when, for how long, what they did with it, etc.) sufficient for an investigation to assemble a complete forensic history of absolutely everything that every user has done in the system on a user, account, and project-level basis

### Document Control

CNBUILDER will handle version control of project documents by storing before and after versions of each document, including information pulled from the public cloud. With a project, the Detail screens (Specification, Submittal, EDP, RFI, and Punchlist) will include a History section that will display links to all prior versions of the same document/data in reverse chronological order with the most recent change(s) at the top of the list. Clicking a History link opens a static (user can only view/close) screen to display the selected version. All document changes within a project trigger an alert visible on a stakeholder Portal screen. History functionality is not depicted on the screen flows presented in Chapter 4 but must be a part of the finished CNBUILDER product.

The foregoing provides the reader with examples and embodiments of the invention, but should not be construed as limiting the proper scope of the invention.

What is claimed is:

1. A graphical user interface system for enhancing the management of budgeting and scheduling of projects serviced by and among a plurality of independent parties, comprising, in combination, the steps of:
providing a color-coded, multi-tier graphical user interface which illustrates a value-based sequence of project data, said interface being capable of providing the system user with physical and virtual product data relating to one or more of the industries such as, without limitation, architecture, construction, and filmmaking;
capturing information relating to at least one particular trade;
presenting captured data as a plurality of mini-projects;
storing and linking data flow activities for a system user operation;
providing based upon resource value and schedule a Web or cloud-based software-as-a-service model in a tree-like interactive graphic;
graphically presenting to the system user the status of a given project;
providing the system user, by one or more color changes, a relatively instantaneous snapshot of project status; and
providing data searchable to the system user on the Web.
